(19) United States
(12) Patent Application Publication
(10) Pub. No.: US 2026/0352608 A1
(43) Pub. Date: Nov. 5, 2026

(54) MESSAGE SEQUENCE CONTROL IN A REQUEST-RESPONSE COMMUNICATION PROTOCOL

(71) Applicant: MOTOROLA SOLUTIONS, INC., CHICAGO, IL (US)

(72) Inventors: YEW LEONG WONG, MELAKA (MY); ELVIN WEI XHUEN SOON, TEMERLOH (MY); JIA SHENG LEI, IPOH (MY)

(21) Appl. No.: 19/196,098

(22) Filed: May 1, 2025

(51) Int. Cl. H04L 47/6275; H04L 47/625; H04W 4/10

(52) U.S. Cl. CPC H04L 47/6275; H04L 47/6255; H04W 4/10

(57) ABSTRACT

First and second communication devices are configured to communicate using a request-response protocol. The first device accrues a plurality of requests and responses destined for the second device. The requests are added to a request queue, and the responses are added to a response queue. The first device removes a request from the request queue and transmits the request to the second device. The first device refrains from transmitting any other requests or responses while waiting for a response from the second device that corresponds to the transmitted request. Once the response is received, the first device continues transmitting requests from the request queue in this manner (delaying subsequent transmissions until corresponding responses are received) until the request queue is empty. Once the request queue is empty, the first device sequentially transmits the responses in the response queue to the second device, adding predefined delays between each response transmission.

### BACKGROUND

Request-response protocols are commonly used in device-to-device communications. Under such protocols, a first device initiates communication by transmitting a request message to a second device. This request message typically includes a demand for data or a directive for a specific action. Upon receiving and processing the request, the second device generates and transmits a response message back to the first device. This response message may include an acknowledgement (also referred to as an ACK) that acknowledges receipt of the request, the requested data, or an indication of the result of an action performed by the second device. As such, this request-response cycle may be used to facilitate the exchange of information and the execution of tasks between networked devices.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 illustrates front, rear, top, bottom, left-side, and right-side views of an example portable communication device.

FIG. 2 illustrates a block diagram of the example portable communication device.

FIG. 3 illustrates a block diagram of an example client device.

FIG. 4 illustrates a sequence diagram of an example request-response communication session between the example portable communication device and the example client device.

FIG. 5 illustrates a flowchart of an example method for regulating the sequence of messages between the portable communication device and the client device.

FIG. 6 illustrates a block diagram of components of an example application for regulating the sequence of messages between the portable communication device and the client device.

FIG. 7 illustrates a flowchart of an example method for preventing the transmission of redundant requests when regulating the sequence of messages between the portable communication device and the client device.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Devices using request-response protocols may take various forms. One example of such a device is a push-to-talk (PTT) portable communication device that interfaces with a client device, such as a smartphone, to facilitate communication in a talk group with other PTT portable communication devices interfacing with other client devices. A commercial example of such a device is the TLK 25 Wearable Communications Device offered by Motorola Solutions, Inc. While the examples described herein are described in connection with such a portable communication device, the present disclosure also contemplates applying the disclosed technology to any other applicable devices that communicate using a request-response protocol.

In an example arrangement, communications between portable communication devices and their respective client devices may comply with a request-response protocol. For instance, when a user originates a call by actuating a PTT button on a portable communication device, the portable communication device may send a request to its connected client device to acquire access to the PTT floor. The client device may respond with an acknowledgement of the request and may take corresponding actions to gain control of the PTT floor. After gaining control of the floor, the client device may then send a request to the portable communication device indicating that the call is connected and requesting audio for transmission to the talk group. The portable communication device may respond with an acknowledgement and proceed to capture speech uttered by the user, digitize the captured speech, and transmit the digitized speech to its connected client device in the form of requests containing talk burst audio packets. The client device may respond to each of these requests with an acknowledgement of receipt. The client device further transmits the received audio to other client devices in the talk group, which may directly output the audio or may engage in similar request-response communications with their connected portable communication devices to cause the portable communication devices to output the audio. Once the user has finished speaking and releases the PTT button, the portable communication device may send a request to its connected client device to release control of the PTT floor. The client device may respond with an acknowledgement of the request and may take corresponding actions to relinquish control of the PTT floor. This is merely one example scenario of how requests and responses are transmitted between the portable communication device and the client device, and various other request-response scenarios are possible as well.

In some scenarios, the portable communication device may generate outgoing requests and/or responses faster than its connected client device can process them. For instance, the request-response protocol employed by the portable communication device and the client device may impose limits on the bandwidth of messages that can be handled at any given time, such as by limiting the rate or number of messages that the client device can concurrently process or queue for processing. One example of such a protocol is the Android Intents protocol, which may be employed by client devices running the ANDROID® operating system offered by Google LLC. While the Android Intents protocol is used herein as an example of such a protocol that limits the bandwidth of messages sent from the portable communication device to the client device, it should be understood that the techniques described herein can similarly be applied to other bandwidth-limiting request-response protocols as applicable.

A client device operating in accordance with the Android Intents protocol is limited to queuing only one Intent at a time for processing. As a result, when the client device already has an Intent queued for processing and the client device receives a new Intent, the client device replaces the queued Intent with the new Intent, thereby causing the replaced Intent to be lost. This can occur in a number of scenarios. One example scenario may arise when the client device initially powers on and receives multiple Intents in rapid succession from other applications running on the client device. If the portable communication device sends an Intent to the client device during this boot-up process, then the Intent may be queued and possibly replaced by another Intent received from one of the other applications. Other example scenarios may arise when the portable communication device generates multiple outgoing Intents in rapid succession, such as during an initialization process in which the portable communication device sends multiple Intents to the client device, or when a user spams the portable communication device with inputs, such as by rapidly actuating and releasing the PTT button. Any other applicable scenarios that cause the transmission of Intents in rapid succession are also contemplated herein.

Discarding queued Intents by the client device in the manner above may result in a number of negative consequences that create a poor user experience. As one example, discarding an Intent for controlling an aspect of a user interface may cause inaccurate information to be presented to the user. As another example, discarding an Intent for initiating a call in the talk group may prevent the call entirely. As yet another example, discarding an Intent during the initialization process of establishing a communication channel between the portable communication device and the client device may cause the portable communication device to fail to initialize properly, potentially leaving the device partially or entirely nonoperational. Thus, there exists a need for an improved technical method, device, and system for controlling the sequencing of messages between devices that are configured to communicate using a response-request protocol with the limitations described above.

One example provides a method for facilitating communication between a first communication device and a second communication device using a request-response protocol. The method comprises: (i) receiving, at the first communication device, (a) a plurality of requests destined for the second communication device, the plurality of requests comprising a first request and a second request, and (b) a plurality of responses destined for the second communication device, the plurality of responses comprising a first response and a second response; (ii) adding the plurality of requests to a first queue for transmission to the second communication device, wherein the first request has priority over the second request in the first queue; (iii) adding the plurality of responses to a second queue for transmission to the second communication device, wherein the first response has priority over the second response in the second queue; (iv) transmitting the first request to the second communication device and removing the first request from the first queue; (v) refraining from transmitting the second request to the second communication device while waiting for a response from the second communication device corresponding to the first request; (vi) receiving, from the second communication device, the response corresponding to the first request; (vii) based on receiving the response corresponding to the first request, transmitting the second request to the second communication device and removing the second request from the first queue; (viii) determining that the first queue is empty; and (ix) based on determining that the first queue is empty, transmitting the plurality of responses to the second communication device and removing the plurality of responses from the second queue.

In some aspects of the method, the method further comprises: (i) while transmitting the plurality of responses to the second communication device, receiving, from the first communication device, a third request for transmission to the second communication device; (ii) based on receiving the third request, temporarily halting transmission of any remaining responses of the plurality of responses in the second queue; (iii) transmitting the third request to the second communication device; (iv) receiving, from the second communication device, a response corresponding to the third request; and (v) based on receiving the response corresponding to the third request, resuming transmission of the remaining responses of the plurality of responses in the second queue. Further, in some aspects, the method further comprises, prior to transmitting the third request to the second communication device: (i) adding the third request to the first queue; and (ii) determining that the first queue is no longer empty, wherein the transmission of the remaining responses of the plurality of responses in the second queue is temporarily halted based on the determining that the first queue is no longer empty. Still further, in some aspects, transmitting the third request to the second communication device comprises removing the third request from the first queue, and the method further comprises, after transmitting the third request to the second communication device, determining that the first queue is empty again, wherein the transmission of the remaining responses of the plurality of responses in the second queue is resumed based on both (i) receiving the response corresponding to the third request and (ii) the determining that the first queue is empty again.

In some aspects of the method, transmitting the plurality of responses to the second communication device comprises adding a time delay between the transmission of each response of the plurality of responses.

In some aspects of the method, the method further comprises: (i) identifying redundant requests from among the plurality of requests in the first queue; and (ii) removing the redundant requests from the first queue, thereby preventing transmission of the redundant requests to the second communication device. Further, in some aspects, the plurality of requests further comprises a fourth request having priority over a fifth request having priority over a sixth request, and wherein identifying redundant requests comprises: (i) determining that (a) the fourth request is a request to initiate a particular service, (b) the fifth request is a request to terminate the particular service, and (c) the sixth request is another request to initiate the particular service, and (ii) responsively identifying the fifth request and the sixth request as redundant requests.

In some aspects of the method, each request of the plurality of requests and each response of the plurality of responses comprises a respective Android Intent.

Another example provides a first communication device configured to communicate with a second communication device using a request-response protocol. The first communication device comprises: (i) at least one processor; and (ii) a non-transitory, computer-readable data storage comprising program instructions that, when executed by the at least one processor, cause the first communication device to perform any or all aspects of the example method described above.

Yet another example provides a non-transitory, computer-readable data storage comprising program instructions that, when executed by at least one processor, cause performance of any or all aspects of the method described above.

Each of the above-mentioned examples will be discussed in more detail below, starting with example system and device architectures of the system in which the embodiments may be practiced, followed by an illustration of processing blocks for achieving an improved technical method, device, and system for controlling message sequences in a request-response protocol.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

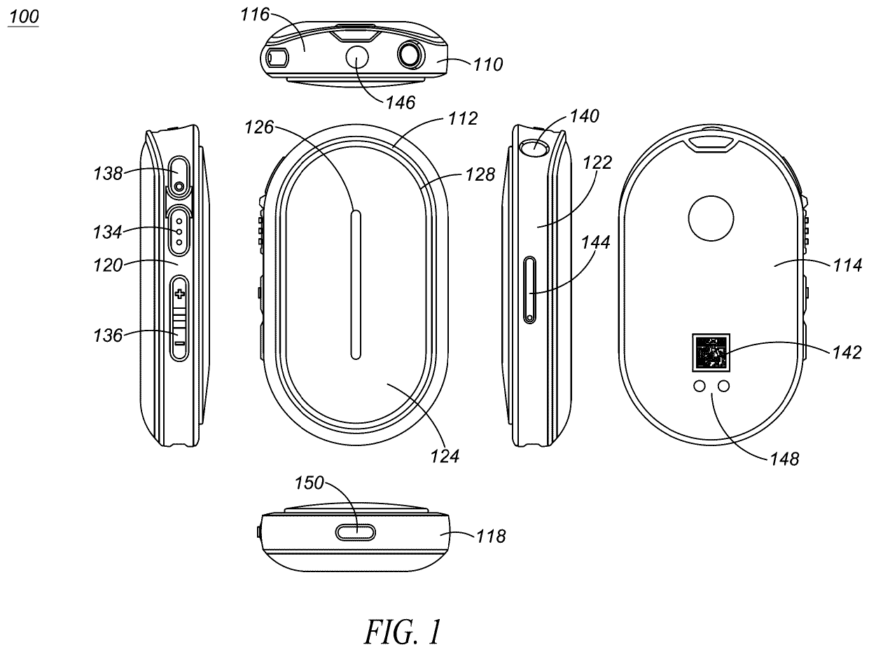

Referring now to the drawings, and in particular FIG. 1, an example implementation of the above-described portable communication device 100 is shown. The portable communication device 100 includes a housing 110 with multiple surfaces including a front surface 112, a rear surface 114, a top surface 116, a bottom surface 118, a left-side surface 120, and a right-side surface 122. The front surface 112 of the housing 110 includes a PTT button 124 (also referred to as a full-front PTT button or a front-facing PTT button) and a light emitting diode (LED) stripe 126 disposed on the PTT button 124. In some examples, the PTT button 124 is large enough to substantially occupy the front surface 112 of the housing 110. As shown in FIG. 1, the PTT button 124 may occupy a substantial portion of the front surface 112 of the housing 110. However, in other examples, the PTT button 124 may take various other suitable shapes or sizes and may be positioned on other portions of the housing 110.

The PTT button 124 is configured to activate transmission of a PTT signal (e.g., when operating in half-duplex communication mode) to other devices in a talk group when the PTT button 124 is depressed by engaging in a request-response communication session with a connected client device in the manner described above. In some examples, any portion of the PTT button 124 located on the front surface of the housing can be depressed to activate PTT transmission, such that the PTT button 124 is configured to be actuated across the entirety of the PTT button 124 surface.

The portable communication device 100 includes a light emitting diode (LED) stripe 126 disposed on the PTT button 124. In some examples, the LED stripe 126 is placed on a flexible cable connecting to a rigid printed circuit board (PCB) disposed in the housing 110 so as to move the LED stripe 126 together with the PTT button 124 when any portion of the front surface 112 of the housing 110 containing the LED stripe 126 and the PTT button 124 is depressed. In these examples, a user can also depress the LED stripe 126 disposed on the front surface 112 of the housing 110 to activate PTT transmission. The LED stripe 126 is configured to be activated to provide a feedback indication comprising at least one of: battery status, connectivity status, volume status, and startup and turn off sequence status.

The portable communication device 100 further comprises a translucent light emitting diode (LED) ring 128 arranged peripheral to the PTT button 124 on the front surface of the housing 110. The LED ring 128 comprises LED elements 130, 132 configured to be activated to provide a feedback indication comprising at least one of: talk group channel status, call status, transmission and reception status, and charging status.

The portable communication device 100 further comprises a voice command button 134, a volume adjustment button 136, a power button 138, and an emergency button 140. The voice command button 134 and the volume adjustment button 136 are disposed on the left-side surface 120 of the housing 110. The power button 138 and the emergency button 140 may be disposed on the top surface 116 of the housing 110. In accordance with embodiments, when the emergency button 140 is depressed, the portable communication device 100 automatically sends an emergency signal over a pre-programmed frequency channel, for example, by reception by dispatch center and other communication devices. In some examples, the portable communication device 100 further includes a slot 142 disposed on the rear surface 114 of the housing 110. The slot 142 is adapted to display a quick response (QR) code or other suitable scannable code that can be used to provide one or more ownership experiences (e.g., device enrollment) to a user of the portable communication device 100. The portable communication device 100 also includes a slot 144 on the right-side surface 122 of the housing 110. The slot 144 may be adapted to receive a subscriber identification module (SIM).

The portable communication device 100 further includes an accessory connector interface 146 (e.g., 3.5 mm speaker connector interface) that is adapted to connect the portable communication device to a wired audio accessory such as a remote speaker microphone (RSM), or other remote audio accessory. The accessory connector interface 146 is disposed on a bottom surface 118 of the housing 110. The portable communication device 100 further comprises one or more charging pins 148 disposed on a rear surface 114 of the housing 110. The portable communication device 100 includes a charging connector interface 150 (e.g., USB-C interface) disposed on the bottom surface 118 of the housing 110.

In accordance with embodiments, the rear surface 114 of the portable communication device 100 is configured to mount to clothing and/or a fixed surface. For instance, the portable communication device 100 may be worn on the belt or the chest to offer better ergonomics to users (e.g., users operating in retail and hospital environments). When worn on the belt, the portable communication device 100 can be attached to a belt clip holster accessory.

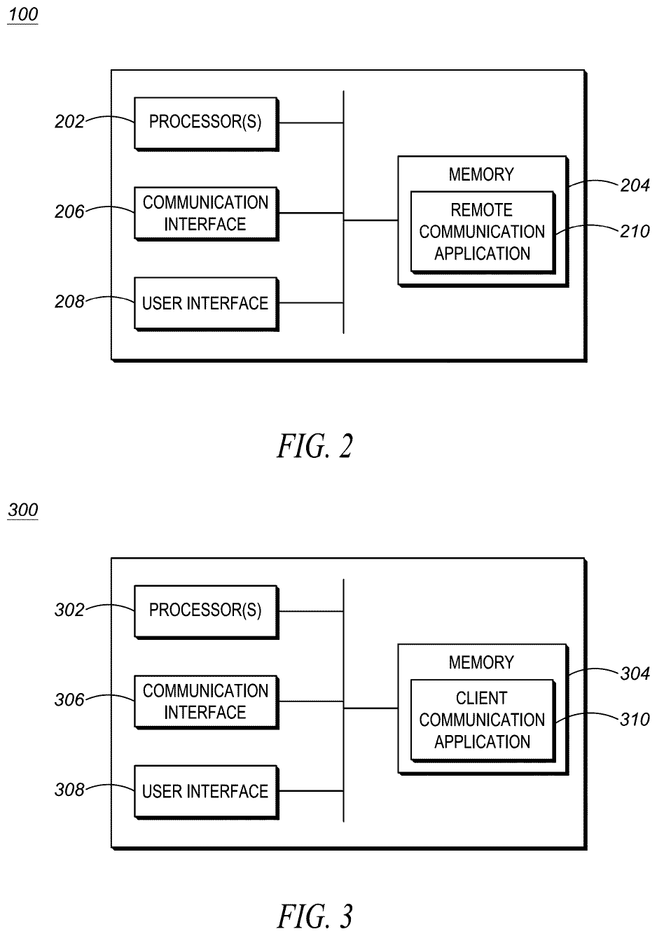

Attention is next directed to FIGS. 2 and 3, which respectively depict schematic block diagrams of the example portable communication device 100 and an example client device 300, which, as noted above, may be implemented as a smartphone in some examples. As depicted, the portable communication device 100 includes one or more processors 202, a memory 204, a communication interface 206, and a user interface 208, all of which may be communicatively linked by one or more communication links, which may take the form of a system bus or some other connection mechanism. Likewise, the client device 300 similarly includes one or more processors 302, a memory 304, a communication interface 306, and a user interface 308, all of which may be communicatively linked by one or more communication links, which may take the form of a system bus or some other connection mechanism.

The processors 202, 302 may comprise one or more processor components, such as general-purpose processors (e.g., a single-or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed.

The memories 204, 304 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. The memories 204, 304 may also be provisioned with software components that enable the portable communication device 100 and the client device 300 to carry out the operations disclosed herein. These software components may generally take the form of program instructions that are executable by the processors 202, 302 to carry out the disclosed operations. For instance, as depicted, the memory 204 of the portable communication device 100 is provisioned with a remote communication application 210, and the memory 304 of the client device 300 is provisioned with a client communication application 310. When executed by their respective processors 202, 302, the remote communication application 210 and the client communication application 310 cause the portable communication device 100 and the client device 300 to communicate with one another in accordance with a response-request protocol, for example in the manners described herein.

The communication interfaces 206, 306 may be configured to facilitate wired and/or wireless communication between the portable communication device 100 and the client device 300 and/or with other computing devices or systems. As such, the communication interface 406 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wired and/or wireless communication. The communication interfaces 206, 306 may also include multiple communication interfaces of different types. Other configurations are possible as well.

The user interfaces 208, 308 may be configured to facilitate direct user interaction with the portable communication device 100 and the client device 300, respectively. In line with the discussion above, the user interface 208 of the portable communication device 100 may include the PTT button 124, the LED stripe 126, the LED ring 128, the voice command button 134, the volume adjustment button 136, the power button 138, the emergency button 140, and/or any user interface accessory connected to the portable communication device 100 by way of the accessory connector interface 146, such as a microphone, headset, speakers, etc. The user interface 308 of the client device 300 may similarly include user interface components for facilitating direct user interaction with the client device 300, examples of which may include a display screen, a touch-sensitive interface, physical buttons, a stylus, a microphone, a headset, speakers, a keyboard, a mouse, etc. Any other suitable user interface components for facilitating direct user interaction with the portable communication device 100 and the client device 300 are also contemplated herein.

It should be understood that the portable communication device 100 and the client device 300 depicted in FIGS. 2 and 3 represent examples of devices that may be used with the embodiments described herein. Numerous other arrangements are possible and contemplated herein. For instance, other portable communication devices and client devices may include additional components not pictured and/or more or fewer of the pictured components.

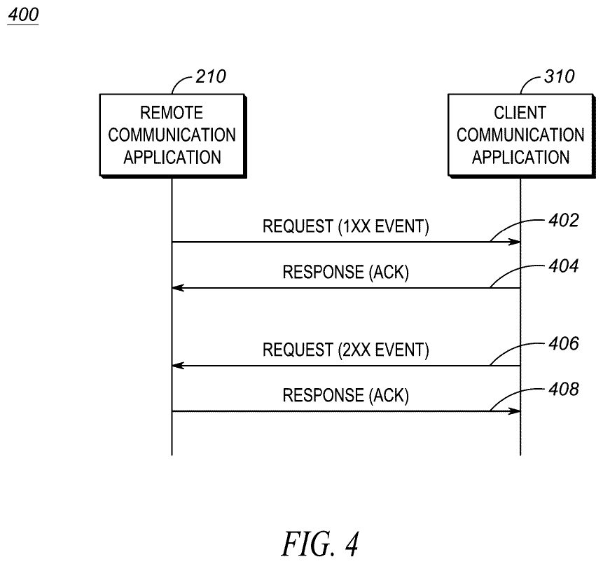

Referring next to FIG. 4, an example sequence diagram 400 is shown depicting request-response communications between the remote communication application 210 of the portable communication device 100 and the client communication application 310 of the client device 300. As depicted, the remote communication application 210 sends a request message 402 to the client communication application 310, and the client communication application 310 sends a corresponding response message 404 to the remote communication application 210 in response to the request message 402. Similarly, at another time, the client communication application 310 sends a request message 406 to the remote communication application 210, and the remote communication application 210 sends a corresponding response message 408 to the client communication application 310 in response to the request message 406.

The request messages 402, 406 sent between the remote communication application 210 and the client communication application 310 may take various forms and may include a header portion and a payload portion. For any given request message, the header portion may include “event-type” data identifying a type of the request message, which depends on the type of event that triggered the transmission of the request message. For example, when a user presses the PTT button 124 of the remote communication device 100, the remote communication application 210 sends a request message to the client communication application 310 with a header portion that includes event-type data corresponding to a down-press of the PTT button 124. And when the user releases the PTT button 124 of the remote communication device 100, the remote communication application 210 sends another request message to the client communication application 310 with a header portion that includes different event-type data corresponding to a release of the PTT button 124.

The event-type data may also take various forms. In the present examples, the event-type data for requests sent from the remote communication application 210 to the client communication application 310 take the form of three-digit numbers beginning with a “1” (i.e., 1XX events), and the event-type data for requests sent from the client communication application 310 to the remote communication application 210 take the form of three-digit numbers beginning with a “2” (i.e., 2XX events). However, any other suitable formats may be used in other examples.

In addition to event-type data, the headers of request messages may further include a transaction identifier. The transaction identifier may include identifying information that can be used to distinguish a given request message from another request message of the same type. For instance, in some examples, the transaction identifier for a given request message may take the form of a numeric or alphanumeric code that is distinct from the numeric or alphanumeric codes of other request messages having the same event-type data in their header.

The payload portion of the request messages may include any data that is to be used by the receiving device of the request message to perform any applicable functions corresponding to the identified event-type. For instance, in line with the examples described above, the payload of a request message corresponding to a press of the PTT button 124 may include data that the client communication application 310 uses to secure the PTT floor of a talk group to which the client device 300 is subscribed. And further in line with the examples above, when the client device 300 is running the ANDROID® operating system, this payload data may include one or more Android Intents, which may be used to control the functionality of the client device 300. However, the payload data may take various other forms as well.

The response messages 404, 408 sent between the remote communication application 210 and the client communication application 310 may also take various forms and may include a header portion and a payload portion similar to that of the request messages. For any given response message, the header portion may include information identifying the message as a response and may further include some or all of the information in the header portion of the corresponding request message to which the response message is responding. Referring to FIG. 4 as an example, the response message 404 is an acknowledgement of the request message 402. As such, the header portion of the response message 404 may include the event-type data and the transaction identifier of the request message 402, which the remote communication application 210 may use to determine that the response message 404 is in response to the request message 402. The payload portion of the response message 404 may then include data indicating a result of the request message 402, such as whether the request was successfully performed, whether the request failed, a mere acknowledgement of receipt of the request, or any other applicable information. Similar to request messages, this payload portion of the response message may include one or more Android Intents when the client device 300 is running the ANDROID® operating system.

As noted above, using a request-response protocol such as those described herein may have undesirable outcomes when the portable communication device 100 generates outgoing request messages and/or response messages faster than the client device 300 can process them. To address these problems, the remote communication application 210 may be configured to regulate the sequence of outbound messages sent to the client communication application 310.

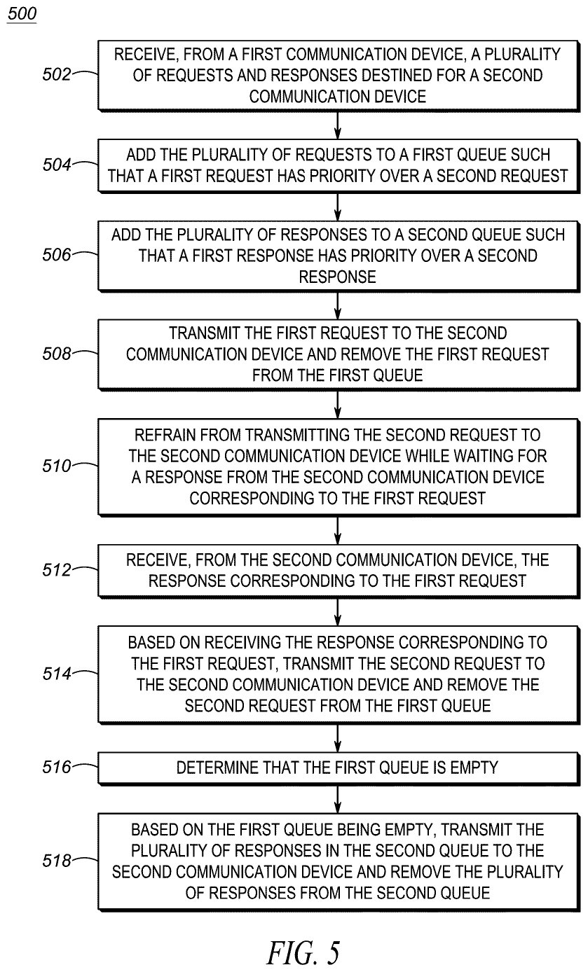

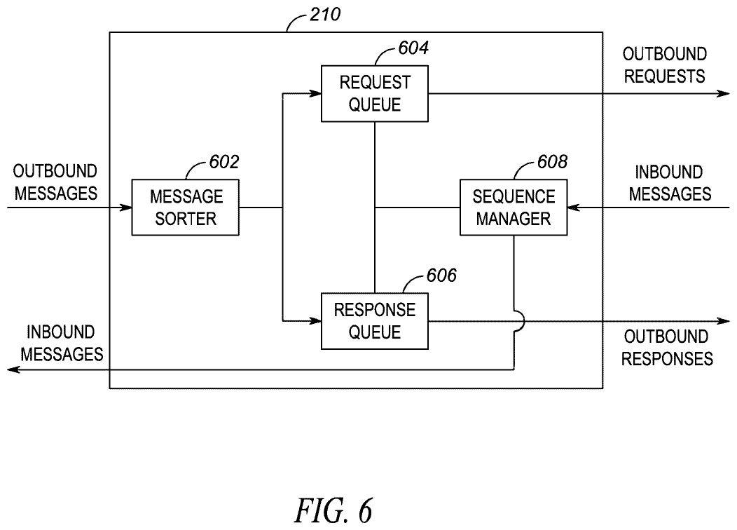

Attention is next directed to FIGS. 5 and 6. FIG. 5 depicts a flowchart of an example method 500 that the remote communication application 210 may perform to regulate the sequence of outbound messages sent to the client communication application 310, thereby preventing the transmission rate of outbound messages from exceeding the capabilities of the client communication application 310. FIG. 6 depicts a block diagram of example components of the remote communication application 210 that may be used to perform the method 500. The operations of the method 500 depicted in FIG. 5 and the functional components of the remote communication application 210 depicted in FIG. 6 correspond to computer-readable instructions that are stored in the memory 204 and executed by the portable communication device 100. Where possible, the method 500 need not be performed in the exact sequence shown, and various operations may be performed in parallel rather than in sequence.

Turning to FIG. 5, at block 502, the method 500 involves receiving, at a first communication device, a plurality of requests and responses destined for a second communication device. In line with the discussion above, the first communication device may take the form of the portable communication device 100, and the second communication device may take the form of the client device 300. Additionally, the plurality of requests and responses may respectively take the forms of the request messages and response messages of the example request-response protocol described herein.

At block 504, the method 500 involves adding the plurality of requests to a first queue, and, at block 506, the method 500 involves adding the plurality of responses to a second queue. As depicted in FIG. 6, this may be performed by a message sorter 602 of the remote communication application 210. The remote communication device 100 may cause any outbound messages to pass through the message sorter 602, which may sort the messages into a request queue 604 (i.e., the first queue) or a response queue 606 (i.e., the second queue) based on whether a given outbound message is a request message or a response message.

When adding the requests to the request queue 604 and the responses to the response queue 606, the message sorter 602 may do so in a manner that prioritizes certain requests over other requests and certain responses over other responses. For instance, the request queue 604 and the response queue 606 may be implemented as linear data structures, such as first-in-first-out (FIFO) data structures. In these examples, the requests in the request queue 604 and the responses in the response queue 606 are prioritized according to their order of joining the queue. As such, the message sorter 602 may add a first request to the request queue 604 followed by adding a second request to the request queue 604, and, in such a scenario, the first request would have priority over the second request in the request queue 604. Similarly, the message sorter 602 may add a first response to the response queue 606 followed by adding a second response to the response queue 606, and, in such a scenario, the first response would have priority over the second response in the response queue 606. However, other prioritization methods may be used in different examples.

As described previously, the portable communication device 100 sends requests to the client device 300 in order to cause the client device 300 to perform various corresponding functions, while the purpose of responses are typically more informative in nature, such as to acknowledge the receipt of a request. As such, it may be desirable to prioritize sending requests to the client device 300 over sending responses, as this may reduce delays in initiating the functions corresponding to the requests. To facilitate this, the remote communication application 210 may further include a sequence manager 608 that controls when the requests and responses in the request queue 604 and response queue 606 are sent to the client device 300. Examples of this functionality will now be described in connection with blocks 508-518 of the method 500.

At block 508, the method 500 involves transmitting the first request in the request queue 604 to the client device 300 and removing the first request from the request queue 604. The sequence manager 608 may control when the requests and responses in the request queue 604 and response queue 606 are sent to the client device 300. For instance, the data structures of the request queue 604 and response queue 606 may include permission status data for each queued request and response indicating whether the respective request or response is permitted to be sent to the client device 300. By default, each queued request and response may have its permission status set to a hold state (i.e., indicating that the message is not permitted to be sent to the client device 300). Then, when the sequence manager 608 determines that a given message is ready for transmission, the sequence manager 608 may change its permission status from the hold state to a transmit state (i.e., indicating that the message is permitted to be sent to the client device 300). Accordingly, at block 508, the sequence manager 608 may change the permission status for the first request from the hold state to the transmit state, and the remote communication application 210 may responsively transmit the first request to the client device 300.

At block 510, the method 500 involves refraining from transmitting the second request in the request queue 604 to the client device 300 while waiting for a response from the client device 300 corresponding to the first request. Further, in addition to refraining from transmitting the second request, the remote communication application 210 may additionally refrain from transmitting any messages at all (i.e., any requests in the request queue 604 and any responses in the response queue 606) to the client device 300. In order to prevent the transmission of such messages, the sequence manager 608 may maintain the permission statuses for any queued messages in the hold state. By preventing the transmission of other messages in this manner, the remote communication application 210 prevents the client device 300 from receiving messages faster than it can process them.

At block 512, the method 500 involves receiving, from the client device 300, the response corresponding to the previously transmitted first request. In line with the discussion above, this response may take the form of an acknowledgement message that acknowledges receipt of the first request. However, other responses are possible as well.

The remote communication application 210 may be configured to determine that the response received at block 512 corresponds to the first request transmitted at block 508. For instance, as depicted in FIG. 6, inbound messages may pass through the sequence manager 608. The sequence manager 608 may inspect the header content of any inbound message, including the response received at block 512, to determine whether the message is a response message and to determine a transaction identifier for the response. The sequence manager 608 may then compare the transaction identifier of the response received at block 512 to the transaction identifier of the first request transmitted at block 508, and when the transaction identifiers match, the sequence manager 608 may determine that the response received at block 512 corresponds to the first request transmitted at block 508. If, however, the transaction identifiers do not match, then the sequence manager 608 may determine that the response received at block 512 does not correspond to the first request transmitted at block 508, and the remote communication application 210 may responsively continue to refrain from transmitting the second request in the request queue 604 (as well as any other requests in the request queue 604 and any responses in the response queue 606) to the client device 300.

At block 514, the method 500 involves, based on receiving the response corresponding to the previously transmitted first request, transmitting the second request in the request queue 604 to the client device 300 and removing the second request from the request queue 604. After transmitting the second request, the remote communication application 210 may again similarly refrain from transmitting any further messages (i.e., any requests in the request queue 604 and any responses in the response queue 606) to the client device 300 while waiting for a response from the client device 300 corresponding to the second request. And the remote communication application 210 may repeat this process of transmitting requests and waiting for responses until all requests in the request queue 604 have been transmitted and the request queue 604 is empty.

At blocks 516 and 518, the method 500 involves determining that the request queue 604 is empty and, based on the request queue 604 being empty, transmitting the plurality of responses in the response queue 606 to the client device 300 and removing the plurality of responses from the response queue 606. In this manner, the remote communication application 210 may prioritize requests over responses by only transmitting the responses to the client device 300 once all requests in the request queue 604 have been transmitted.

As was the case when transmitting requests to the client device 300, the remote communication application 210 may similarly employ additional techniques when transmitting responses to the client device 300 to ensure that the client device 300 does not receive the responses faster than it can process them. However, unlike requests, the client device 300 may not provide any indication that a response has been received and processed. Accordingly, instead of refraining from transmitting a subsequent response until receiving a corresponding message from the client device 300, the remote communication application 210 may be configured to meter the transmissions of the responses in the response queue 606 by adding a time delay between the transmission of each response in the response queue 606. The time delay may be a predetermined and/or user configurable time delay and should be of sufficient length to allow the client device 300 to process the previously transmitted response. In some examples, the time delay may be specified in milliseconds (e.g., 100 ms, 200 ms, 500 ms, or 1000 ms). However, the time delay may be longer or shorter in other examples, depending on the processing capabilities of the client device 300.

In some examples, the remote communication application 210 may receive or generate an outbound request message while in the process of transmitting the responses in the response queue 606 to the client device 300 (i.e., while the request queue 604 is empty and the response queue 606 includes one or more responses scheduled for transmission to the client device 300). For instance, during the process of transmitting the responses in the response queue 606 to the client device 300, the user of the remote communication device 100 may press or release the PTT button 124, thereby generating a new outbound request corresponding to the user action. As described above in connection with block 504, the message sorter 602 may add this new outbound request to the request queue 604. And as further described above, it may be desirable to prioritize the transmission of requests over responses. Thus, instead of continuing to transmit responses in the response queue 606 to the client device, the sequence manager 608 may be configured to interrupt the transmission of responses to prioritize the transmission of the new outbound request. For instance, the sequence manager 608 may determine that the request queue 604 is no longer empty (e.g., by detecting the new outbound request in the request queue 604) and, in response, may temporarily halt the transmission of any remaining responses in the response queue 606 until the new outbound request has been transmitted to and processed by the client device 300. Namely, the sequence manager 608 may cause the new outbound request to be transmitting to the client device 300 and may cause the remote communication application 210 to refrain from sending any other messages to the client device 300 until the remote communication application 210 receives a response corresponding to the new outbound request in the manner described above. Once the sequence manager 608 receives the response corresponding to the new request and determines that the request queue 604 is once again empty, then the sequence manager 608 may cause the remote communication application 210 to resume transmission of the remaining responses in the response queue 606 to the client device 300.

Further, in some examples, the remote communication application 210 may be configured to take additional steps to reduce congestion in the request queue 604 by preemptively identifying redundant requests from the plurality of requests and discarding such redundant requests, thereby preventing their transmission to the client device 300.

In the context of the example portable communication device 100 described herein, redundant requests may arise when the user of the device 100 repeatedly provides the same user input faster than the requests corresponding to the user inputs are processed by the client device 300. In some examples, these user inputs may come in offsetting pairs, such that one type of user input is always followed by another user input of a different opposing type. One example of an offsetting pair is when the user presses and releases the PTT button 124. The press of the PTT button 124 generates a first request message, and the release of the PTT button 124 generates a second request message. Due to the nature of the operation of the PTT button 124, a press of the PTT button 124 will always be followed at some point by a release of the PTT button 124. As such, these two types of requests corresponding to the press and release of the PTT button 124 are offsetting pairs of requests.

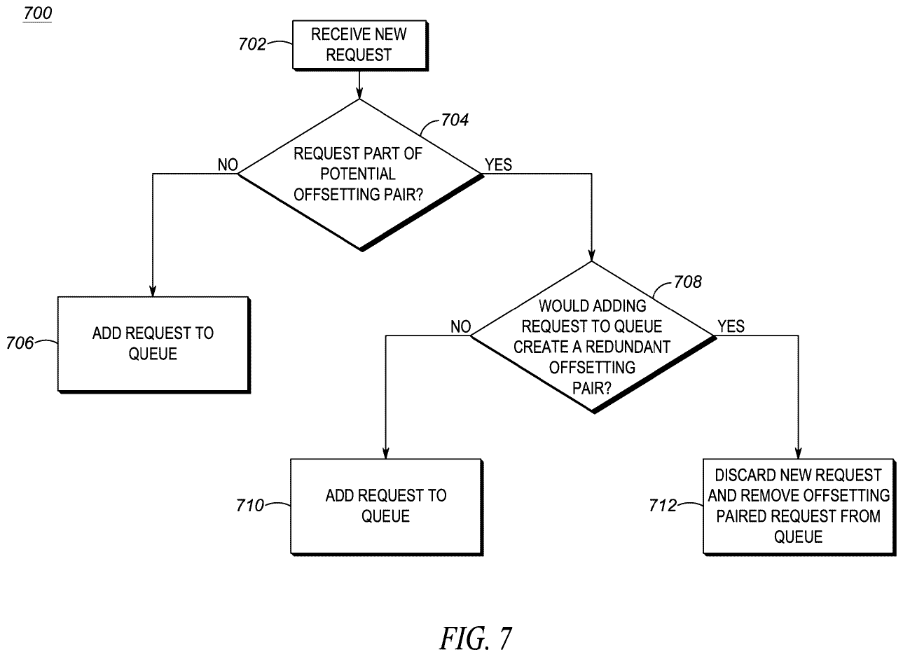

FIG. 7 depicts a flowchart of an example method 700 that the remote communication application 210 may perform to discard redundant offsetting requests before they are transmitted to the client device 300, thereby reducing the number of requests sent to the client device 300 and improving the speed at which the client device 300 can process the requests in the request queue 604. The operations of the method 700 correspond to computer-readable instructions that are stored in the memory 204 and executed by the portable communication device 100. Where possible, the method 700 need not be performed in the exact sequence shown, and various operations may be performed in parallel rather than in sequence.

At block 702, the method 700 involves receiving a new request, and at block 704, the method 700 involves determining whether the received request is part of a potential offsetting pair. In order to determine whether the request is part of a potential offsetting pair, the remote communication application 210 may be provisioned with information specifying the types of requests that are offsetting pairs of requests. As noted above, one such example of an offsetting pair of requests is the pair of requests corresponding to the press and release of the PTT button 124 are offsetting pairs of requests. Thus, in one example, the remote communication application 210 may determine whether the received request is part of a potential offsetting pair by determining whether the received request is a request corresponding to a press or release of the PTT button 124. If the received request is not one of these pre-specified types of requests, then the method 700 advances to block 706 where the remote communication application 210 adds the request to the request queue 604. If, on the other hand, the received request is one of these pre-specified types of requests, then the remote communication application 210 determines that the request is potentially part of an offsetting pair of requests, and the method 700 advances to block 708.

At block 708, the method 700 involves determining whether adding the request to the request queue 604 would create a redundant offsetting pair. A redundant offsetting pair occurs when the request queue 604 includes at least one offsetting pair of requests in addition to at least one more of the request types found in the offsetting pair. To illustrate, consider the example of the press and release of the PTT button 124 described above and assume that the request queue 604 already includes a PTT-press-request followed by a PTT-release-request (i.e., corresponding to the user pressing and then releasing the PTT button 124 faster than the requests are transmitted to and processed by the client device 300). In this scenario, if the user were to press the PTT button 124 again, then the newly received request would be another PTT-press-request. Adding this new request to the request queue 604 would result in a PTT-press-request followed by a PTT-release-request followed by a PTT-press-request. Processing all of these requests in sequence would result in the equivalent functionality of only processing the initial PTT-press-request, as the functionalities corresponding to the later-received requests offset one another (i.e., because they are a redundant offsetting pair).

Accordingly, in some examples, the determination at block 708 may involve (i) determining that the request queue 604 includes a request to initiate a particular service (e.g., a PTT-press-request) followed by a request to terminate the particular service (e.g., a PTT-release-request) and (ii) determining that the newly received request at block 702 is another request to initiate the particular service (e.g., another PTT-press-request). Conversely, in some examples, the determination at block 708 may involve (i) determining that the request queue 604 includes a request to terminate a particular service (e.g., a PTT-release-request) followed by a request to initiate the particular service (e.g., a PTT-press-request) and (ii) determining that the newly received request at block 702 is another request to terminate the particular service (e.g., another PTT-release-request). If these determinations are made in the affirmative, then the remote communication application 210 determines that adding the newly received request to the request queue 604 would create a redundant offsetting pair. Otherwise, the remote communication application 210 determines that adding the newly received request to the request queue 604 would not create a redundant offsetting pair.

In response to determining that adding the newly received request to the request queue 604 would not create a redundant offsetting pair, the method 700 advances to block 710 where the remote communication application 210 adds the newly received request to the request queue 604.

In response to determining that adding the newly received request to the request queue 604 would create a redundant offsetting pair, the method 700 advances to block 712 where the remote communication application 210 discards the newly received request (e.g., by refraining from adding the request to the request queue 604) and further removes the lowest priority offsetting paired request from the request queue 604. To illustrate, let us continue with the example of the press and release of the PTT button 124 described above in which the request queue 604 already includes a PTT-press-request followed by a PTT-release-request, and the newly received request at block 702 is another PTT-press-request. In this scenario, the newly received PTT-press-request would be discarded at block 712, as would the lowest priority offsetting paired request in the request queue 604. As noted above, an offsetting pair in the context of the PTT button 124 includes both a PTT-press-request and a PTT-release-request. As such, the lowest priority offsetting paired request corresponding to the discarded PTT-press-request would be the lowest priority PTT-release-request in the request queue 604. By discarding both the newly received PTT-press-request and the previously queue PTT-release-request, the only remaining request in the request queue 604 is the initial PTT-press-request. And, as noted above, processing this single PTT-press-request request provides the equivalent functionality of processing the three PTT-press-request, PTT-release-request, and PTT-press-request. But processing a single request instead of three requests reduces the computational demands of the client device 300 and the amount of time taken to perform the functionalities corresponding to the requests, thereby improving the functioning of the devices 100, 300 and improving the user experience.

As should be apparent from this detailed description above, the operations and functions of the electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot control the transmission rate and sequence of electronic messages in accordance with a request-response protocol, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for facilitating communication between a first communication device and a second communication device using a request-response protocol, the method comprising:
receiving, at the first communication device, (i) a plurality of requests destined for the second communication device, the plurality of requests comprising a first request and a second request, and (ii) a plurality of responses destined for the second communication device, the plurality of responses comprising a first response and a second response;
adding the plurality of requests to a first queue for transmission to the second communication device, wherein the first request has priority over the second request in the first queue;
adding the plurality of responses to a second queue for transmission to the second communication device, wherein the first response has priority over the second response in the second queue;
transmitting the first request to the second communication device and removing the first request from the first queue;
refraining from transmitting the second request to the second communication device while waiting for a response from the second communication device corresponding to the first request;
receiving, from the second communication device, the response corresponding to the first request;
based on receiving the response corresponding to the first request, transmitting the second request to the second communication device and removing the second request from the first queue;
determining that the first queue is empty; and
based on determining that the first queue is empty, transmitting the plurality of responses to the second communication device and removing the plurality of responses from the second queue.

2. The method of claim 1, further comprising:
while transmitting the plurality of responses to the second communication device, receiving, from the first communication device, a third request for transmission to the second communication device;
based on receiving the third request, temporarily halting transmission of any remaining responses of the plurality of responses in the second queue;
transmitting the third request to the second communication device;
receiving, from the second communication device, a response corresponding to the third request; and
based on receiving the response corresponding to the third request, resuming transmission of the remaining responses of the plurality of responses in the second queue.

3. The method of claim 2, further comprising, prior to transmitting the third request to the second communication device:
adding the third request to the first queue; and
determining that the first queue is no longer empty, wherein the transmission of the remaining responses of the plurality of responses in the second queue is temporarily halted based on the determining that the first queue is no longer empty.

4. The method of claim 3, wherein transmitting the third request to the second communication device comprises removing the third request from the first queue, and wherein the method further comprises:
after transmitting the third request to the second communication device, determining that the first queue is empty again, wherein the transmission of the remaining responses of the plurality of responses in the second queue is resumed based on both (i) receiving the response corresponding to the third request and (ii) the determining that the first queue is empty again.

5. The method of claim 1, wherein transmitting the plurality of responses to the second communication device comprises adding a time delay between the transmission of each response of the plurality of responses.

6. The method of claim 1, further comprising:
identifying redundant requests from among the plurality of requests in the first queue; and
removing the redundant requests from the first queue, thereby preventing transmission of the redundant requests to the second communication device.

7. The method of claim 6, wherein the plurality of requests further comprises a fourth request having priority over a fifth request having priority over a sixth request, and wherein identifying redundant requests comprises:
determining that (i) the fourth request is a request to initiate a particular service, (ii) the fifth request is a request to terminate the particular service, and (iii) the sixth request is another request to initiate the particular service, and responsively identifying the fifth request and the sixth request as redundant requests.

8. The method of claim 1, wherein each request of the plurality of requests and each response of the plurality of responses comprises a respective Android Intent.

9. A first communication device configured to communicate with a second communication device using a request-response protocol, the first communication device comprising:
at least one processor; and
a non-transitory, computer-readable data storage comprising program instructions that, when executed by the at least one processor, cause the first communication device to perform a set of operations comprising:
receiving (i) a plurality of requests destined for the second communication device, the plurality of requests comprising a first request and a second request, and (ii) a plurality of responses destined for the second communication device, the plurality of responses comprising a first response and a second response;
adding the plurality of requests to a first queue for transmission to the second communication device, wherein the first request has priority over the second request in the first queue;
adding the plurality of responses to a second queue for transmission to the second communication device, wherein the first response has priority over the second response in the second queue;
transmitting the first request to the second communication device and removing the first request from the first queue;
refraining from transmitting the second request to the second communication device while waiting for a response from the second communication device corresponding to the first request;
receiving, from the second communication device, the response corresponding to the first request;
based on receiving the response corresponding to the first request, transmitting the second request to the second communication device and removing the second request from the first queue;
determining that the first queue is empty; and
based on determining that the first queue is empty, transmitting the plurality of responses to the second communication device and removing the plurality of responses from the second queue.

10. The first communication device of claim 9, the set of operations further comprising:
while transmitting the plurality of responses to the second communication device, receiving, from the first communication device, a third request for transmission to the second communication device;
based on receiving the third request, temporarily halting transmission of any remaining responses of the plurality of responses in the second queue;
transmitting the third request to the second communication device;
receiving, from the second communication device, a response corresponding to the third request; and
based on receiving the response corresponding to the third request, resuming transmission of the remaining responses of the plurality of responses in the second queue.

11. The first communication device of claim 10, the set of operations further comprising, prior to transmitting the third request to the second communication device:
adding the third request to the first queue; and
determining that the first queue is no longer empty, wherein the transmission of the remaining responses of the plurality of responses in the second queue is temporarily halted based on the determining that the first queue is no longer empty.

12. The first communication device of claim 11, wherein transmitting the third request to the second communication device comprises removing the third request from the first queue, and wherein the set of operations further comprises:
after transmitting the third request to the second communication device, determining that the first queue is empty again, wherein the transmission of the remaining responses of the plurality of responses in the second queue is resumed based on both (i) receiving the response corresponding to the third request and (ii) the determining that the first queue is empty again.

13. The first communication device of claim 9, wherein transmitting the plurality of responses to the second communication device comprises adding a time delay between the transmission of each response of the plurality of responses.

14. The first communication device of claim 9, the set of operations further comprising:
identifying redundant requests from among the plurality of requests in the first queue; and
removing the redundant requests from the first queue, thereby preventing transmission of the redundant requests to the second communication device.

15. A non-transitory, computer-readable data storage comprising program instructions that, when executed by at least one processor, cause performance of a set of operations for facilitating communication between a first communication device and a second communication device using a request-response protocol, the set of operations comprising:
receiving, at the first communication device, (i) a plurality of requests destined for the second communication device, the plurality of requests comprising a first request and a second request, and (ii) a plurality of responses destined for the second communication device, the plurality of responses comprising a first response and a second response;
adding the plurality of requests to a first queue for transmission to the second communication device, wherein the first request has priority over the second request in the first queue;
adding the plurality of responses to a second queue for transmission to the second communication device, wherein the first response has priority over the second response in the second queue;
transmitting the first request to the second communication device and removing the first request from the first queue;
refraining from transmitting the second request to the second communication device while waiting for a response from the second communication device corresponding to the first request;
receiving, from the second communication device, the response corresponding to the first request;
based on receiving the response corresponding to the first request, transmitting the second request to the second communication device and removing the second request from the first queue;
determining that the first queue is empty; and
based on determining that the first queue is empty, transmitting the plurality of responses to the second communication device and removing the plurality of responses from the second queue.

16. The first communication device of claim 9, the set of operations further comprising:
while transmitting the plurality of responses to the second communication device, receiving, from the first communication device, a third request for transmission to the second communication device;
based on receiving the third request, temporarily halting transmission of any remaining responses of the plurality of responses in the second queue;
transmitting the third request to the second communication device;
receiving, from the second communication device, a response corresponding to the third request; and
based on receiving the response corresponding to the third request, resuming transmission of the remaining responses of the plurality of responses in the second queue.

17. The first communication device of claim 10, the set of operations further comprising, prior to transmitting the third request to the second communication device:
adding the third request to the first queue; and
determining that the first queue is no longer empty, wherein the transmission of the remaining responses of the plurality of responses in the second queue is temporarily halted based on the determining that the first queue is no longer empty.

18. The first communication device of claim 11, wherein transmitting the third request to the second communication device comprises removing the third request from the first queue, and wherein the set of operations further comprises:
after transmitting the third request to the second communication device, determining that the first queue is empty again, wherein the transmission of the remaining responses of the plurality of responses in the second queue is resumed based on both (i) receiving the response corresponding to the third request and (ii) the determining that the first queue is empty again.

19. The first communication device of claim 9, wherein transmitting the plurality of responses to the second communication device comprises adding a time delay between the transmission of each response of the plurality of responses.

20. The first communication device of claim 9, the set of operations further comprising:
identifying redundant requests from among the plurality of requests in the first queue; and
removing the redundant requests from the first queue, thereby preventing transmission of the redundant requests to the second communication device.
